(19) United States
(12) Patent Application Publication
(10) Pub. No.: US 2017/0246656 A1
(43) Pub. Date: Aug. 31, 2017

(54) METHOD AND APPARATUS FOR MANUFACTURING A TAPE

(71) Applicant: ESSENTRA PACKAGING & SECURITY LIMITED, Nottingham, Nottinghamshire (GB)

(72) Inventor: Philip ALLEN, Nottinghamshire (GB)

(21) Appl. No.: 15/120,483

(22) PCT Filed: Feb. 24, 2015
(86) PCT No.: PCT/EP2015/053784

§ 371 Date: Aug. 19, 2016

(30) Foreign Application Priority Data
Feb. 24, 2014 (GB) 1403230.4

(51) Int. Cl. B05D 1/28; B31D 1/00; B05D 7/00; B65H 18/10; B05D 3/12; B31D 1/02; B65H 35/02

(52) U.S. Cl. CPC B05D 1/28; B31D 1/021; B31D 1/026; B31D 1/0062; B31D 1/027; B65H 35/02; B65H 18/103; B05D 3/12; B05D 7/54; B65H 2301/4148; B65H 2701/11332

(57) ABSTRACT

There is disclosed a method of manufacturing an adhesive tape (32), comprising: printing a print pattern (14) including at least one printed datum (15) onto a web; applying onto the web a plurality of transversely spaced adhesive stripes (16) using an adhesive stripe applicator; and controlling adhesive stripe application such that the adhesive stripes (16) are applied in register with the print pattern (14) by monitoring the transverse position of at least a part of at least one printed datum (15) and adjusting the relative transverse position between the adhesive stripe applicator and the web in response thereto. The method also comprises a tape slitting operation in which, using a tape slitting head (92), the web is slit into a plurality of adhesive tapes (32) which each have an adhesive stripe (16); and controlling the tape slitting such that the web is slit in register with the print pattern (14) by monitoring the transverse position of at least a part of at least one printed datum (15) and adjusting the relative transverse position between the tape slitting head (92) and the web in response thereto.

The invention relates to a method and apparatus for manufacturing a tape, in particular although not exclusively, a method and apparatus for manufacturing a reclose tape having an adhesive stripe.

Products are frequently provided in packaging which can be opened to provide access to the product. If the product is perishable, for example if it is a food stuff, it may be desirable to reclose the packaging in order to keep the product fresh. For example, pasta, rice or chocolate is often provided in a flexible filmic bag. It is known to provide an adhesive reseal label or tape which is releasably adhered to the outside of the bag and which can be used to reclose, or reseal, the bag. The label or tape can be peeled away from the bag and adhered to a folded down part of the bag to reclose it. It is known to provide the label or tape with a non-adhesive, or dry, fingerlift in order to make it easier for the user to peel the label or tape away from the bag.

In one previously considered arrangement, a reclose tape is provided which has a longitudinally extending adhesive layer and a coextensive dry fingerlift along the edge of the tape. The reclose tape is typically manufactured by laminating two layers together with an overlap. With conventional manufacturing techniques, it can be difficult to manufacture reclose tapes to high tolerances.

It is therefore desirable to provide an improved method and apparatus for manufacturing adhesive tapes.

According to an aspect there is provided a method of manufacturing an adhesive tape, comprising: printing a print pattern including at least one printed datum onto a web; applying onto the web a plurality of transversely spaced adhesive stripes using an adhesive stripe applicator; controlling adhesive stripe application such that the adhesive stripes are applied in register with the print pattern by monitoring the transverse position of at least a part of at least one printed datum and adjusting the relative transverse position between the adhesive stripe applicator and the web in response thereto. The method may further comprise a tape slitting operation in which, using a tape slitting head, the web is slit into a plurality of adhesive tapes which each have an adhesive stripe; and controlling the tape slitting such that the web is slit in register with the print pattern by monitoring the transverse position of at least a part of at least one printed datum and adjusting the relative transverse position between the tape slitting head and the web in response thereto. The web subject to tape slitting may be a narrower web (or a width of a web) of the web to which the print pattern and adhesive stripes are applied. There may therefore be a primary slitting operation in between printing/coating and tape slitting. Since the adhesive stripes are applied in register with the print pattern, and the tape slitting is carried out in register with the print pattern, the tape slitting is indirectly carried out in register with the adhesive stripes.

The width of the adhesive stripes may be uniform. The transverse spacing may be uniform. The transverse spacing may be greater than the width of the adhesive stripes. The transverse spacing may be the same as the width of the adhesive tape. The adhesive stripes may be applied in register with one another. Therefore, the relative transverse positioning between the plurality of adhesive stripes may be constant or fixed in the web direction. The adhesive stripe applicator may comprise a coating cylinder such as a gravure coating cylinder. The adhesive stripes may be applied using a gravure coating process. All of the plurality of adhesive stripes may be applied with a single coating cylinder. The adhesive stripes may be applied using a reverse gravure coating process. Of course, any suitable coating technique could be used including three roll reverse. The web may be drawn or fed in the web direction. Each adhesive stripe may be continuous (in the web direction) or may be discontinuous (e.g. a “dotted” adhesive stripe), or may be patterned (e.g. a zig-zag or a hatched stripe).

The adhesive stripes may be stripes of a clear adhesive. The adhesive stripes may be stripes of a pressure-sensitive adhesive. The adhesive stripes may be stripes of a reseal adhesive.

The print pattern may comprise a plurality of transversely spaced printed datums. The or each or some of the printed datums may comprise printed lines or printed markers. The or each printed datum may extend in the web direction. The print pattern may be printed using one or more print cylinders. The print pattern may be printed using a gravure printing process. The print pattern may include graphics, text, patterns, logos or any other suitable graphics.

Controlling the adhesive stripe application may comprise optically monitoring the transverse position of at least a part of at least one printed datum. Adjusting the relative transverse position between the adhesive stripe applicator and the web may comprise transversely moving the web.

Tape slitting may be carried out in the web direction in line (i.e. in the same direction) or parallel to the adhesive stripes. Tape slitting in (transverse) register with the print pattern means that the transverse locations of the transversely spaced slitting lines (which extend in the web direction) have a fixed relationship to the print pattern. Since the adhesive stripes are applied in register with the print pattern, slitting in register with the print pattern also results in slitting in register with the adhesive stripes.

The adhesive tape may have a single adhesive stripe. The adhesive tape may be slit into a plurality of adhesive tapes which each have an adhesive stripe and one or two non-adhesive edges. The adhesive tape may be a reclose tape (alternatively referred to as a reseal tape). The relative transverse position between the tape slitting head and the web may be periodically or continually automatically adjusted. The web may be drawn or fed in the web direction. The web may be subject to the tape slitting operation as it is drawn (or fed) through the tape slitting head. The web may be continuously slit. The method may be a continuous process.

The adhesive tape, such as a reclose/reseal tape, may comprise a longitudinally extending adhesive stripe, such as a reseal (or reclose) adhesive stripe, and at least one longitudinally extending non-adhesive edge region forming a fingerlift. The adhesive stripe may be coextensive with the reclose tape. The adhesive stripe may be continuous in the length (or web) direction, or it may be discontinuous or patterned. For example, the adhesive stripe could be a “dotted” stripe, a zig-zag stripe, or a hatched stripe. The reclose tape may comprise first and second longitudinally extending non-adhesive edge regions forming first and second fingerlifts. The longitudinally extending adhesive stripe may be located substantially centrally. The or each fingerlift may be adhesive free or deadened. The web substrate may form the base layer of the adhesive tape.

The width of each adhesive stripe may be 50 mm or less, 40 mm or less, 30 mm or less, 20 mm or less, 15 mm or less, 10 mm, or 5 mm or less. The width of each adhesive stripe may be between 1-50 mm, 2-40 mm, 3-30 mm, 2-20 mm, 4-10 mm, or 5-8 mm. The width of each tape may be 50 mm or less, 40 mm or less, 30 mm or less, 20 mm or less, 15 mm or less, or 10 mm or less. The width of each tape may be between 1-60 mm, 2-50 mm, 3-40 mm, 2-30 mm, 4-20 mm, or 5-10 mm.

The plurality of transversely spaced adhesive stripes may be located side-by-side across the web direction. There may be gaps, or spaces, between adjacent adhesive stripes. The transverse spacing between the adhesive stripes may be greater than the width of the adhesive stripes. The transverse spacing (centreline to centreline) between the adhesive stripes may be uniform. The transverse spacing between the adhesive stripes may be the same as the width of the adhesive tape. The adhesive stripes may longitudinally and continuously extend in the web direction. The adhesive stripes may be formed by discrete stripes of adhesive. The adhesive stripes may be formed by printing or coating stripes of a deadening layer over a continuous layer of adhesive.

The web may be a filmic substrate. The web may be a slittable substrate. The web may be made from a material such as mono-oriented polypropylene (MOPP), polypropylene (PP), bi-oriented polypropylene (BOPP), polyethylene terephthalate (PET), polyethylene (PE) or paper. The web may be clear or transparent.

Controlling the tape slitting may comprise optically monitoring the transverse position of at least a part of at least one printed datum. Adjusting the relative transverse (cross-web direction) position between the tape slitting head and the web may comprise transversely moving the tape slitting head. This may keep the slitting in register with the print pattern and hence the adhesive stripes. The tape slitting head may be used to guide the tape slitting. The web may be slit at positions in between adjacent adhesive stripes such that each adhesive tape comprises a central adhesive region or stripe disposed between non-adhesive edge regions.

The slitting head may comprise a plurality of transversely spaced slitting elements. The tape slitting elements may comprise blades or knives or lasers, for example. The transverse spacing (centre-to-centre) between the tape slitting elements may be fixed during use. It may be possible to adjust the transverse positions of the tape slitting elements during set-up. The transverse spacing between the plurality of tape slitting elements may substantially correspond to the transverse spacing between the plurality of adhesive stripes. The transverse spacing between the plurality of tape slitting elements may substantially correspond to the width of the adhesive tape.

The method may further comprise rewinding each adhesive tape onto a reel. The adhesive tapes may be self-wound. The adhesive tapes may be traverse wound.

The method may further comprise applying a release coating onto the opposite side of the web to the side to which the adhesive stripes are applied. The release coating may be a silicone release coating and/or may be continuous.

The method may further comprise a primary slitting operation, which is carried out prior to the tape slitting operation in which, using a primary slitting head, the web is slit into a plurality of narrower webs which each have a plurality of transversely spaced adhesive stripes, wherein each narrower web is subsequently subject to the tape slitting operation. The web may be drawn or fed in the web direction. The web may be subject to the primary slitting operation as it is drawn (or fed) through the primary slitting head. The web may be continuously slit.

The method may further comprise controlling the primary slitting by monitoring the transverse position of at least a part of at least one printed datum and adjusting the relative transverse position between the primary slitting head and the web in response thereto. The printed datum may comprise a printed marker or line on the web. The transverse position of at least a part of at least one printed datum may be optically monitored. Primary slitting may be carried out in the web direction. Primary slitting may slit the web in register (i.e. a fixed transverse relationship) with the printed datum and therefore the print pattern as a whole. This may result in the web being slit in transverse register with the adhesive stripes. The relative transverse position between the primary slitting head and the web may be periodically or continually automatically adjusted.

Adjusting the relative transverse (cross-web direction) position between the primary slitting head and the web may comprise transversely moving the primary slitting head with respect to the web. This may keep the slitting in register with the printed datum and the adhesive stripes.

The primary slitting head may comprise a plurality of transversely spaced primary slitting elements. The primary slitting elements may comprise blades or knives or lasers, for example. The transverse spacing between the primary slitting elements may be fixed during use. It may be possible to adjust the transverse positions of the primary slitting elements during set-up. The transverse spacing between the plurality of primary slitting elements may substantially correspond to the width of the narrow web.

The method may further comprise rewinding each narrower web onto a reel. The webs may be self-wound. In other embodiments the narrower webs may be applied onto a backing sheet or structure before winding.

According to an aspect there is provided an apparatus for manufacturing an adhesive tape, the apparatus comprising: a printing station for printing a print pattern including at least one printed datum onto a web; a coating station comprising: an adhesive stripe applicator for applying onto the web a plurality of transversely spaced adhesive stripes; an adhesive stripe applicator controller arranged to control the application of adhesive stripes such that they are applied in register with the print pattern, comprising: a datum monitor arranged to monitor the transverse position of at least a part of at least one printed datum; and an adjuster arranged to adjust the relative transverse position between the adhesive stripe applicator and the web based on the monitored transverse position. The apparatus may further comprise one or more tape slitting stations, each comprising: a tape slitter comprising a tape slitting head through which the web can be drawn so as to slit the web into a plurality of adhesive tapes which each have an adhesive stripe; and a tape slitting controller arranged to control the tape slitting such that the web is slit in register with the printed pattern, the tape slitting controller comprising: a datum monitor arranged to monitor the transverse position of at least a part of at least one printed datum; and a tape slitting adjuster arranged to adjust the relative transverse position between the tape slitting head and the web based on the monitored transverse position.

The or each or some of the printed datums may comprise printed lines or printed markers. The or each printed datum may extend in the web direction. The printing station may comprise one or more print cylinders. The printing station may comprise one or more gravure printing cylinders.

The adhesive stripe applicator may be arranged to apply the adhesive stripes in register with one another. The adhesive stripe applicator may comprise one or more adhesive coating cylinders. The adhesive stripe applicator may comprise one or more gravure coating cylinders.

The datum monitor of the adhesive stripe applicator controller may comprise an optical monitor arranged to optically monitoring the transverse position of at least a part of at least one printed datum. The adjuster of the adhesive stripe applicator controller may be arranged to transversely move the web.

The datum monitor of the tape slitting controller may comprise an optical monitor arranged to optically monitor the transverse position of at least a part of at least one printed datum. The adjuster of the tape slitting controller may be arranged to transversely move the tape slitting head.

The tape slitter may be arranged to slit the web at positions in between adjacent adhesive stripes such that each adhesive tape comprises a central adhesive region disposed in between non-adhesive edge regions. The tape slitting head may comprise a plurality of transversely spaced slitting elements. The tape slitting elements may comprise blades or knives. The transverse spacing between the tape slitting elements may be fixed. The transverse spacing between the plurality of tape slitting elements may substantially correspond to the transverse spacing between the plurality of adhesive stripes.

The tape slitting station may further comprise a plurality of rewinders each for rewinding one of the plurality of adhesive tapes onto a reel.

The coating station may be arranged to apply a release coating onto the opposite side of the web to the side to which the coating station is arranged to apply adhesive stripes onto.

The apparatus may further comprise a primary slitting station comprising: a primary slitter comprising a primary slitting head through which the web can be drawn so as to slit the web into a plurality of narrower webs which each have a plurality of transversely spaced adhesive stripes.

The primary slitting station may further comprise a primary slitting controller arranged to control the primary slitting, the primary slitting controller comprising: a datum monitor arranged to monitor the transverse position of at least a part of at least one printed datum; and a primary slitting adjuster arranged to adjust the relative transverse position between the primary slitting head and the web based on the monitored transverse position.

The datum monitor may comprise an optical monitor arranged to optically monitor the transverse position of at least a part of at least one printed datum. The primary slitting adjuster may be arranged to transversely move the primary slitting head based on the monitored transverse position. The primary slitting head may comprise a plurality of transversely spaced primary slitting elements. The primary slitting elements may comprise blades or knives. The transverse spacing between the primary slitting elements may be fixed.

The primary slitting station may further comprise a plurality of rewinders each for rewinding one of the plurality of narrower webs onto a reel.

There may be a plurality of tape slitting stations.

The invention may comprise any combination of the features and/or limitations referred to herein, except combinations of such features as are mutually exclusive.

Embodiments of the invention will now be described, by way of example, with reference to the accompanying drawings, in which:

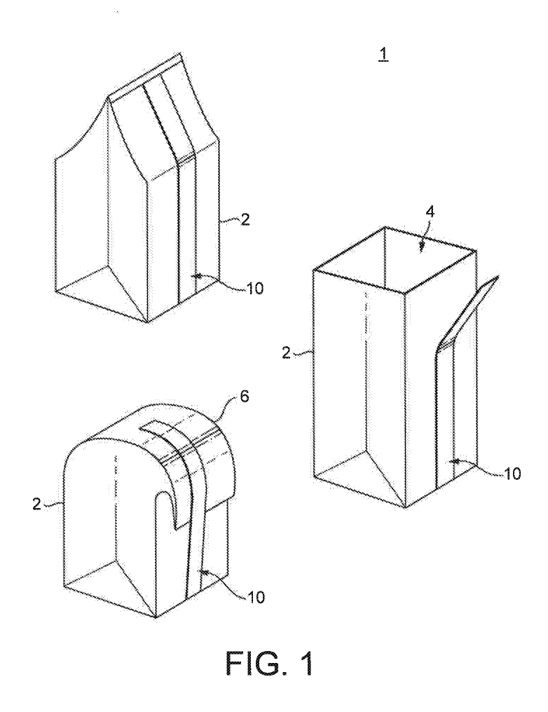

FIG. 1 schematically shows product packaging having a strip of reclose tape applied to the outside;

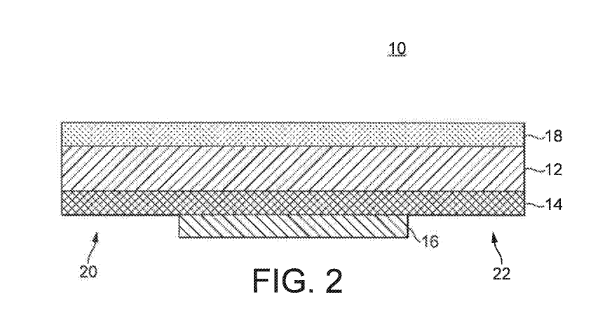

FIG. 2 schematically shows a cross-sectional view of the reclose tape of FIG. 1;

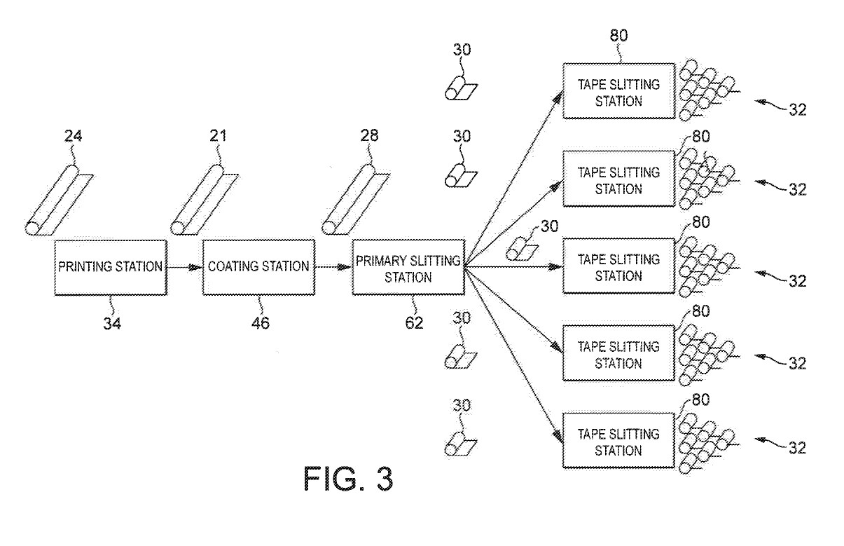

FIG. 3 schematically shows a manufacturing apparatus for manufacturing a reel of reclose tape;

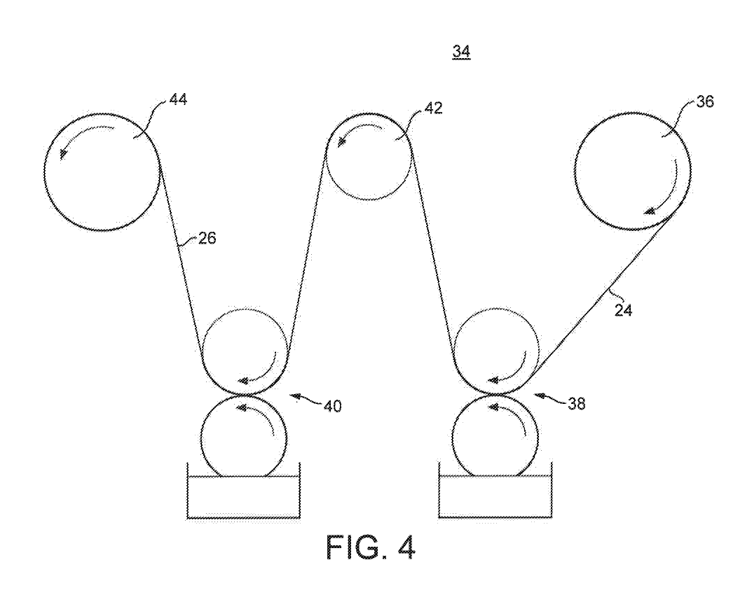

FIG. 4 schematically shows the printing station of FIG. 3;

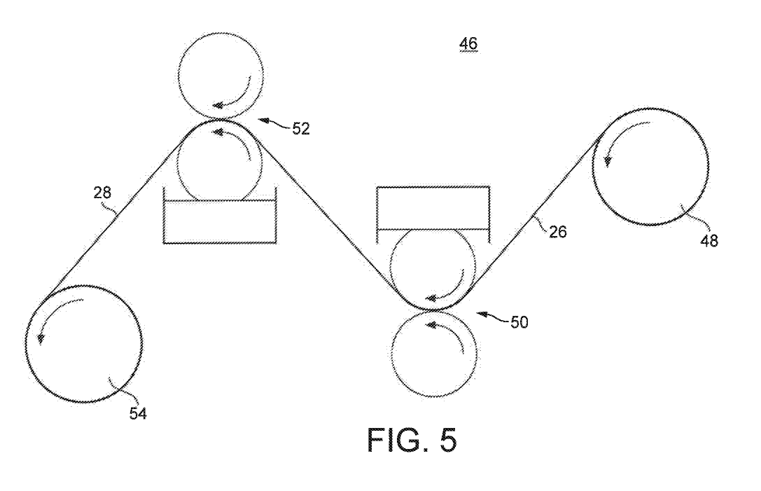

FIG. 5 schematically shows the coating station of FIG. 3;

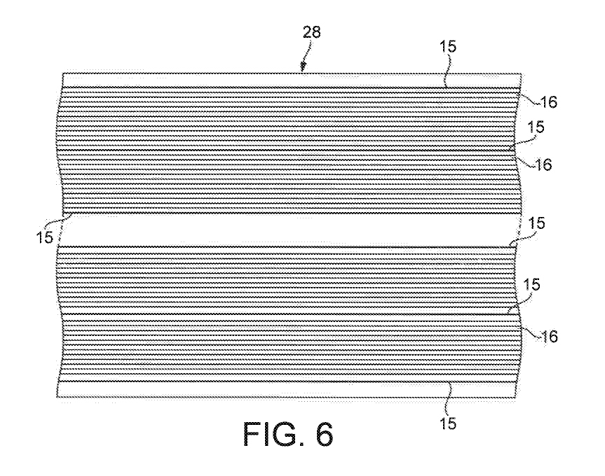

FIG. 6 schematically shows a plan view of a printed and coated web;

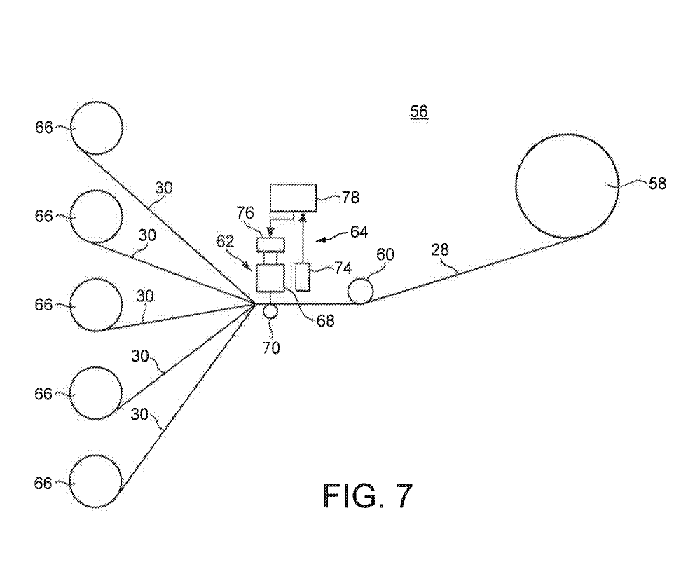

FIG. 7 schematically shows the primary slitting station of FIG. 3;

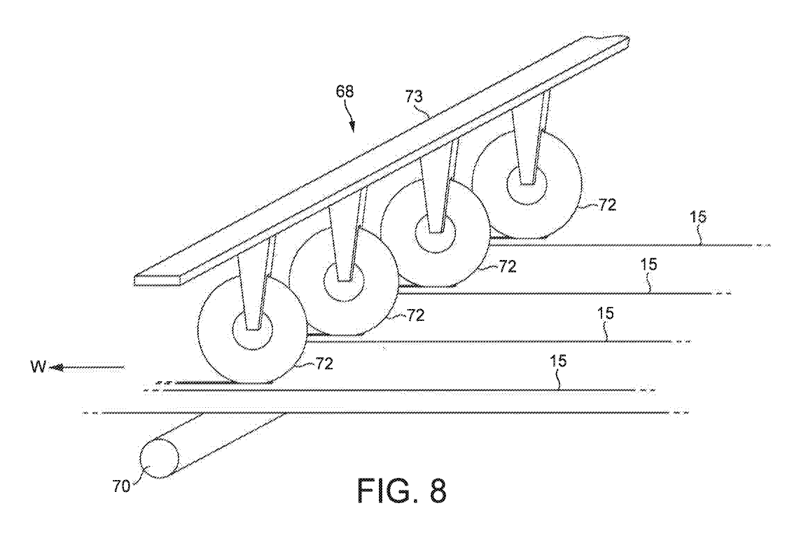

FIG. 8 schematically shows the primary slitter of FIG. 7;

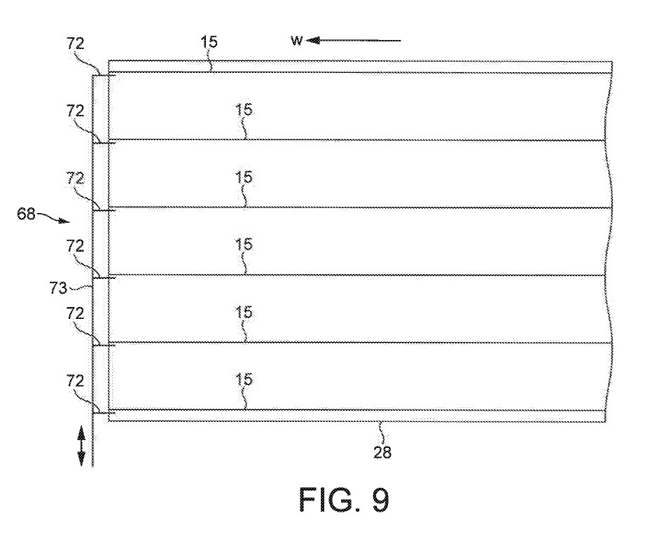

FIG. 9 schematically shows a plan view of the primary slitting operation;

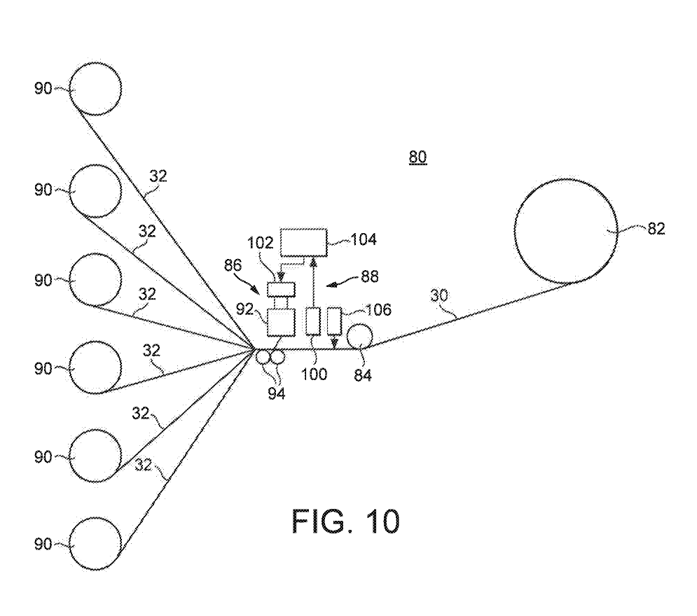

FIG. 10 schematically shows the tape slitting station of FIG. 3;

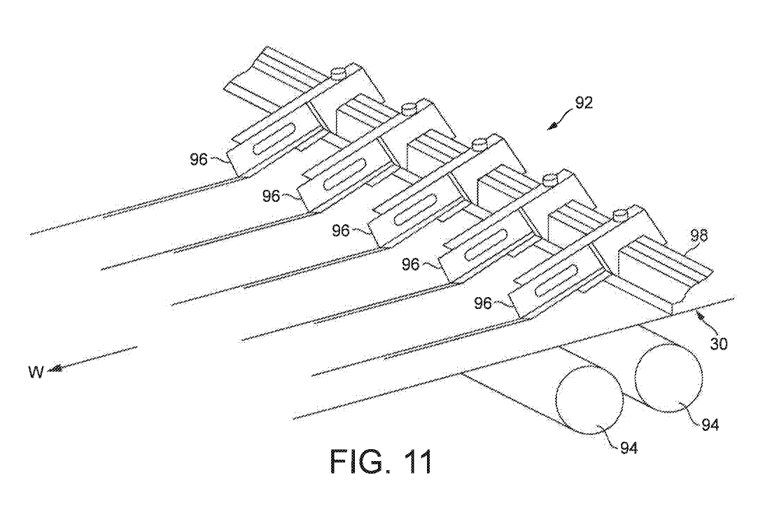

FIG. 11 schematically shows the tape slitter of FIG. 10; and

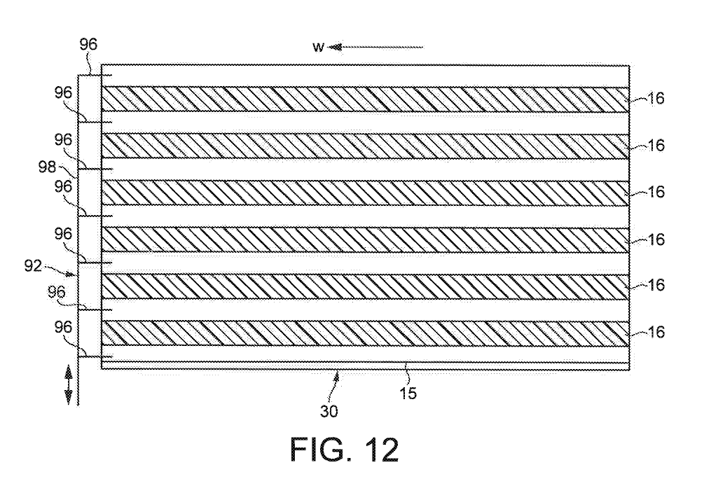

FIG. 12 schematically shows a plan view of the tape slitting operation.

FIG. 1 shows product packaging 1 in the form of a bag 2 containing a food product, such as pasta or rice, for example. The bag 2 is made from a filmic substrate and is manufactured and filled using a conventional vertical form film process. The bag 2 is provided with an elongate strip of reclose tape 10 (sometimes referred to as reseal tape) which is releasably adhered to the outer surface of the bag 2. A user can open the bag 2 to form an opening 4 such that the product can be removed from the bag 2. In order to close the bag 2, the reclose tape 10 is peeled away from the outer surface of the bag 2, the top 6 of the bag 2 is folded or rolled down and the reclose tape is readhered over the folded down top 6 of the bag 2 so as to keep the bag 2 closed. This prevents the product from falling out of an open bag, and also helps to maintain the freshness of the product.

The strip of reclose tape 10 is an elongate strip of tape and is applied to the outside of the bag 2 from a self-wound reel of reclose tape during the packaging process. The tape 10 may be applied continuously or discrete lengths may be repeated applied during the manufacturing process. Referring to FIG. 2, the strip of reclose tape 10 comprises a base film layer 12 which in this embodiment is a clear (i.e. transparent) mono-oriented polypropylene (MOPP) film. It should be appreciated that other suitable materials could be used for the base layer, for example, the base layer 12 could be polypropylene (PP), bi-oriented polypropylene (BOPP), polyethylene terephthalate (PET), polyethylene (PE) or paper. The base layer 12 may be a single layer or a laminate. The lower surface of the base layer 12 is printed with a print layer 14 which may be a pattern, a continuous colour, or text, for example. The print layer 14 is viewable from the upper side of the base layer 12. A clear (i.e. transparent) adhesive stripe 16 is provided on the lower surface of the print layer 14 and extends in the same direction as the tape. The adhesive may be a rubber or acrylic based adhesive and may either be a hot melt, emulsion, or a solvent based adhesive. The adhesive stripe 16 is elongate and coextensive with the base layer 12 and is narrower than the width of the base layer 12. In this embodiment the width of the base layer 12 is 10 mm and the width of the adhesive stripe 16 is 5 mm. The adhesive stripe 16 is continuous in the length direction, but in other embodiments the adhesive stripe 16 could be broken in the length direction. In this embodiment, the adhesive stripe 16 is located centrally with respect to the base layer 12 and therefore the underside of the base layer 12/print layer 14 has dry, or non-adhesive, edge regions 20, 22 that are elongate and extend along the entire length of the reclose tape 10, each having a width of 2.5 mm. It should be appreciated that other suitable dimensions could be chosen. The dry-edge regions 20, 22 provide a fingerlift on each side of the reclose tape 10 along the entire length of the tape 10. In use, this allows a user to easily grasp the reclose tape 10 such that it can be peeled away from the packaging. It is important to control the location of the adhesive stripe 16 with respect to the base layer 12 so that the fingerlifts 20, 22 have the appropriate width. For example, if the adhesive stripe 16 is too close to one side of the base layer 12 then one of the fingerlifts 20, 22 will be too small, and the other will be too large. Although it has been described that the reclose tape 10 has two fingerlifts 20, 22, one each side of the adhesive stripe 16, in other embodiments only one fingerlift may be provided. The upper surface of the base layer 12 is provided with a silicone release layer 18 which allows the reclose tape 10 to be supplied as a self-wound reel (i.e. without a release liner). In other embodiments, a the tape 10 may be supplied on a backing sheet/release liner.

A method and apparatus for manufacturing a self-wound reel of reclose tape (or reseal) from which lengths of reclose tape 10 can be cut will now be described.

Referring to FIG. 3, in this embodiment there are four main separate stages in the manufacture of a self-wound reel of reclose tape. The manufacturing stages are as follows and will be described in detail below:
(A) a printing station 34 in which a wide web 24 of mono-oriented polypropylene, which forms the base layer 12, is printed with a print layer or pattern 14;
(B) a coating station 46 in which a plurality of transversely spaced adhesive stripes 18 (either continuous or discontinuous adhesive stripes) extending in the web direction are applied to the lower surface of the printed web 26, and in which the upper surface of the printed web 26 is coated with a release layer 18;
(C) a primary slitting station 62 in which the printed and coated wide web 28 is slit in the web direction into a number of narrower webs 30; and
(D) a number of tape slitting stations 80 in which a narrower printed and coated web 30 is slitted and wound into a number of reels of reclose tapes 32.

As shown in FIG. 4, the printing station 34 comprises a reel holder 36 onto which a wide web 24 of mono-oriented polypropylene can be loaded, first and second printing stages 38, 40, a guide roller 42 and a rewinder 44. The printing station 34 is arranged to draw the web 24 from the reel holder 36 through the first printing stage 38, over the guide roller 42, through the second printing stage 40 and the rewinder 44 is arranged to rewind the printed web 26 onto a reel. In this embodiment, the web 24 has a width of approximately 1000 mm, but it should be appreciated that the web may have any suitable width. The first and second printing stages 38, 40 are gravure printing stages and each comprise a gravure printing cylinder, an ink fountain, an impression roller, and a doctor blade (not shown). In use, the gravure printing cylinder picks up ink from the ink fountain, and the doctor blade scrapes off any excess ink so that ink only resides in the engraved (patterned) areas of the printing cylinder. The gravure printing cylinder then applies the ink to the web 24. In this embodiment there are two printing stages 38, 40. The first printing stage 38 prints a continuous colour, for example red, whilst the second printing stage 40 prints a continuous pattern as well as 16 transversely and uniformly spaced datum lines 15 (the purpose of these lines will be described below). The printed datum lines 15 continuously extend in the web direction, and are spaced across the web (i.e. transversely). It should be appreciated that in other embodiments there may be a different number of printing stages, and any suitable printing technique could be used, for example, offset printing.

As shown in FIG. 5, the coating station 46 comprises a reel holder 48 onto which the printed web 26 can be loaded, a release application stage 50, an adhesive application stage 52 and a rewinder 54. The coating station 46 is arranged to draw the web 26 from the reel holder 48 through the release application stage 50, through the adhesive application stage 52 and the rewinder 54 is arranged to rewind the printed web 26 onto a reel. The release application stage 50 is a gravure coating stage comprising a gravure release coating cylinder, a release coating fountain, an impression roller, and a doctor blade (not shown). The release application stage 50 is arranged to apply a continuous layer 18 of a release coating (such as a silicone release coating) to the entire width and length of the web 26. Accordingly, the gravure release coating cylinder has an engraved pattern around its entire circumference and of a width that corresponds to that of the web 26. In use, the gravure release coating cylinder picks up release coating from the release coating fountain, and the doctor blade scrapes off any excess release coating so that release coating only resides in the engraved area of the release coating cylinder. The gravure release coating cylinder then applies the release coating to the web 26. A continuous release coating is applied across the entire width and length of the web 26.

The adhesive application stage 52, like the release application stage 50, is a gravure coating stage comprising a gravure adhesive coating cylinder, an adhesive coating fountain, an impression roller, and a doctor blade (not shown). The adhesive application stage 52 is arranged to apply a plurality of transversely spaced adhesive stripes 16 to the web 26 over the print layer 14 (i.e. on the opposing side to the side the release coating 18 is applied to). The adhesive used to form all of the adhesive stripes 16 is clear (i.e. transparent). The gravure adhesive coating cylinder has an engraved pattern in the form of a plurality of circumferentially extending rings that are spaced from one another across the axial (or transverse) direction of the cylinder. If the adhesive stripes 16 are to be discontinuous along their length (e.g. a “dotted” stripe), each engraved pattern may be a number of circumferentially extending recesses that are circumferentially spaced from one another. If the adhesive stripes 16 are to be patterned, the engraved pattern on the cylinders will correspond to this (e.g. zip-zag shaped or hatched shape). In use, the gravure adhesive coating cylinder picks up the adhesive from the adhesive coating fountain, and the doctor blade scrapes off any excess release coating so that adhesive only resides in the engraved areas (i.e. the rings) of the adhesive coating cylinder. The gravure adhesive coating cylinder then applies a plurality of transversely spaced continuous adhesive stripes 16 to the web 26. However, in other embodiments the adhesive stripes 16 could be discontinuous. The adhesive stripes 16 extend in the web direction, and are spaced across the web (i.e. transversely). In this embodiment the adhesive application stage 52 is arranged to apply 90 transversely spaced adhesive stripes in 15 groups. Each adhesive stripe has a width of 5 mm, and within each group of stripes, there is a 5 mm gap between adjacent adhesive stripes 16. Within each group, the transverse distance, or spacing, between the longitudinal centrelines of adjacent adhesive stripes 16 is therefore 10 mm. As shown in FIG. 6, the adhesive application stage 52 (adhesive stripe applicator) is arranged such that a group of six adhesive stripes 16 is applied between each pair of adjacent printed datum lines 15.

In this embodiment, the coating stage 46 is configured to continuously and automatically maintain register (i.e. transverse alignment) between the print layer 14 and the pattern of adhesive stripes 16. In order to achieve this, the coating stage 46 comprises an adhesive stripe applicator controller 47 comprising an optical datum monitor 49 in the form of a camera, a web feed adjuster 51 which can adjust the transverse position of the web 26 relative to the adhesive application stage 52, and a control unit 53 which is connected to the monitor 49 and the adjuster 51. The adhesive stripe applicator controller 47 is arranged to automatically control the application of the adhesive stripes 16 such that they are applied in register with the print layer (pattern) 14. This ensures that the pattern of adhesive stripes 16 have a fixed positional relationship with respect to the print layer 14 including the datum lines 15.

In use, with the web 26 being drawn in the web direction, the optical datum monitor 49 visually monitors the transverse position of one of the datum lines 15 printed on the web 26. Based on the monitored position, the control unit 53 causes the web feed adjuster 51 to automatically transversely move the web 26 (if necessary) to ensure that the adhesive stripes 16 are applied in transverse register (i.e. in a fixed transverse positional relationship) with the print patter 14. There is therefore a fixed positional relationship between the adhesive stripes 16 and the printed datum line 15 (and hence the entire print pattern 14).

Although it has been described that the release coating and adhesive stripes are applied by a gravure coating process in which the gravure coating cylinder rotates in the same direction as the direction of travel of the web, in other embodiments the coating process may be a reverse gravure coating process or a reverse three roll process. Further, other suitable coating processes could be used.

Referring now to FIG. 7, the primary slitting station 56 comprises a reel holder 58 onto which the printed coated web 28 can be loaded, a guide roller 60, a primary slitter 62, a primary slitting controller 64, and 15 rewinders 66 (only five are shown for the purposes of clarity). The primary slitting station 56 is arranged to draw the printed coated web 28 through the primary slitter 62 which performs a primary slitting operation to slit the web 28 into 15 narrower webs 30 which are each rewound by a rewinder 66 onto a reel. The primary slitter 62 comprises a primary slitting head 68 and a planten roll 70. As shown in FIG. 8, the slitting head 68 comprises a plurality, in this case 16 primary slitting elements 72 in the form of circular knives that act against the planten roll 70 (only four are shown in FIG. 8). The primary slitting elements 72 are transversely uniformly spaced from one another and are fixed relative to one another, by attachment to a beam 73, for example. It may be possible to finely adjust the transverse spacing of the primary slitting elements 72 manually. The primary slitting elements 72 are spaced across the width of the web 28 and the transverse spacing between the centreline of each primary slitting element 72 corresponds to the width of each narrow web 30, and also the transverse spacing between adjacent printed datum lines 15. In this embodiment, the primary slitting elements 72 are spaced by 65 mm. As the web 28 is drawn through the primary slitter 62 between the primary slitting elements 72 and the planten roll 70, the web 28 is slit in the web direction into 15 narrower webs 30 (each having a width of 65 mm), with each narrower web 30 having six transversely spaced continuously extending adhesive stripes 16. As will be described below, the primary slitting head 68 is moveable in the transverse direction with respect to the web 28 which allows the transverse positions at which the web 28 is slit to be adjusted.

The primary slitting controller 64 comprises an optical datum monitor 74 in the form of a camera, a primary slitting adjuster 76 which can adjust the transverse position of the primary slitting head 68 relative to the web 28, and a control unit 78 which is connected to the monitor 74 and adjuster 76. The primary slitting controller 64 is arranged to automatically control the primary slitting operation such that the web 28 is slit into 15 narrower webs 30 in register with the print layer 14. This ensures that the web 28 is slit at the desired transverse positions. Slitting in register with the print layer means that a predetermined and fixed positional relationship is maintained between the slitting positions and the print pattern and hence the adhesive stripes. In this embodiment, the web 28 is slit along lines that are parallel to and transversely spaced from the datum lines 15. However, in other embodiments the web 28 may be slit along the datum lines 15. Since the web 28 is slit along lines spaced from the datum lines 15, each narrower web 30 slit from the wider web has a printed datum line 15 that extends in the web direction.

With reference to FIG. 9, in use, with the web 28 being drawn in the web direction W, the optical datum monitor 74 visually monitors the transverse position of one of the datum lines 15 printed on the web 28. Based on the monitored position, the control unit 78 causes the primary slitting adjuster 76 to automatically adjust the transverse position of the primary slitting head 68 (if necessary) to ensure that the slitting elements 72 are aligned next to the datum lines 15 (i.e. so the slitting elements 72 are slightly transversely spaced from the datum lines 15). The web 30 is therefore slit along lines spaced from the datum lines 15. The primary slitting controller 64 continuously monitors the transverse position of the datum line 15 and adjusts the relative position between the primary slitting head 68 to ensure that the web 28 is slit in register with (although not along) the datum lines 15, and therefore the print layer as a whole and hence the adhesive stripes 16. Although not described in detail, there is some wastage at the edges of the web 28 that is disposed of.

In this embodiment there are 15 tape slitting stations 80, one for each narrower web 30. Referring now to FIG. 10, each tape slitting station 80 comprises a reel holder 82 onto which one of the narrower webs 30 can be loaded, a guide roller 84, a tape slitter 86, a tape slitting controller 88, and six traverse rewinders 90. The tape slitting station 80 is arranged to draw the narrower web 30 through the tape slitter 86 which performs a tape slitting operation to slit the web 30 into six narrower reclose tapes 32 which are each traverse rewound by a rewinder 90 onto a reel. Each reclose tape 32 has a single central adhesive stripe 16 which extends in the web direction and two dry-edge fingerlifts 20, 22 which also extend in the web direction (FIG. 2). The tape slitter 86 comprises a tape slitting head 92 and two guide rollers 94. As shown in FIG. 11, the tape slitting head 92 comprises a plurality, in this case seven tape slitting elements 96 in the form of razor blades (only five are shown in FIG. 11). The tape slitting elements 96 are transversely uniformly spaced from one another and are fixed relative to one another by attachment to a beam 98. It may be possible to manually finely adjust the transverse spacing of the tape slitting elements 92. The tape slitting elements 96 are spaced across the width of the web 30 and the transverse spacing between the centreline of each tape slitting element 96 corresponds to the width of each reclose tape 32, and also to the transverse centreline spacing between adjacent adhesive stripes 16. In this embodiment, the tape slitting elements 96 are spaced by 10 mm. As the narrow web 30 is drawn through the tape slitter 86 between the tape slitting elements 96 and the guide rollers 96, the web 30 is slit in the web direction at transverse positions in between adjacent adhesive stripes 16 into six reclose tapes 32 (each having a width of 10 mm). Each reclose tape has a single continuous adhesive stripe 16 and two dry-edge fingerlifts 20, 22. As will be described below, the tape slitting head 92 is moveable in the transverse direction with respect to the web 30 which allows the transverse positions at which the web 30 is slit to be adjusted.

The tape slitting controller 88 comprises an optical adhesive stripe monitor 100 in the form of a camera, a tape slitting adjuster 102 which can adjust the transverse position of the tape slitting head 92 relative to the web 30, and a control unit 104 which is connected to the monitor 100 and adjuster 102. The tape slitting controller 88 is arranged to automatically control the tape slitting operation such that the web 30 is slit into six reclose tapes 32 in register (i.e. in transverse alignment) with the print layer 14. However, since the adhesive stripe 16 are applied in register with the print layer 14, the slitting is also in register with the adhesive stripes 16. This ensures that the web 30 is slit at the desired transverse positions. In this embodiment the tape stilling controller 88 is arranged to control the tape slitting operation such that the web 30 is slit at the mid-point between each pair of adjacent adhesive stripe 16, such that the web 30 is slit into reclose tapes 32 having a central adhesive region 16 and two dry-edge fingerlift regions 20, 22. Slitting in register with the print layer 14, and therefore also the adhesive stripes 16, means that a predetermined and fixed positional relationship is maintained between the slitting positions and the pattern of adhesive stripes 16. It is not necessary that the web 30 slit along lines coincident with the edges of adhesive stripes 16, but in some embodiments this may be the case.

With reference to FIG. 12, in use, the optical adhesive stripe monitor 100 visually monitors the transverse position of the printed datum 15 at the edge of the narrower web 30. Based on the monitored position, the control unit 104 causes the tape slitting adjuster 102 to automatically adjust the transverse position of the tape slitting head 92 (if necessary) to ensure that the tape slitting elements 96 are transversely aligned with the mid-point between adjacent adhesive stripes 16, along which it is desired to slit the web 30. The tape slitting controller 86 continuously monitors the position of the printed datum 15 and adjusts the relative position between the tape slitting head 92 and the web 30 to ensure that the web 30 is slit in register with the printed datum 15 (and therefore the print pattern 14 and the adhesive stripes 16). Although not described in detail, there is some wastage at the edges of the web 30 that is disposed of. The tape slitting operation results in six reclose tapes 16, each having a width of 10 mm, with a central adhesive stripe 16 having a width of 5 mm, and two dry-edge fingerlifts 20, 22 having a width of 2.5 mm each (FIG. 2). The reclose tapes 32 are traverse wound into a self-would reel of tape.

In this embodiment, slitting in register with the print layer 14 ensures that the adhesive stripe 16 is centrally located on each reclose tape 32, and therefore the widths of the dry-edge fingerlifts 20, 22 are equal. This is achieved because the adhesive stripes 16 are applied in register with the print layer 14. Since the above described embodiment the tape 32 is of a relatively narrow width of 10 mm, and the widths of the fingerlifts 20, 22 is 2.5 mm, it is important that the tape slitting is carried out in register with the adhesive stripes 16. For example, a 1.5 mm error between the desired slitting locations and the actual slitting locations would cause the fingerlifts 20, 22 to have sizes of 0.5 mm and 4.5 mm which would have a drastic impact on the quality of the product. Therefore, slitting in transverse register with the print pattern 14 and hence the adhesive 16 ensures a high-quality end product.

Although it has been described that the primary slitting controller is arranged to control the primary slitting by transversely moving the primary slitting head relative to the web, it should be appreciated that the relative transverse position between the primary slitting head and the web could be achieved in other ways. For example, the web could be moved transversely with respect to the primary slitting head. Similarly, as opposed to moving the tape slitting head relative to the web, the relative transverse position between the tape slitting head and the web could be adjusted by transversely moving the web relative to the tape slitting head. Further, the adhesive stripe applicator controller may be arranged to adjust the transverse position of the adhesive stripe coating cylinder, as opposed to the web itself.

It has been described that the manufacturing process includes printing, coating, primary slitting and tape slitting, and that there are corresponding stations for carrying out each process. However, it may be the case that in some embodiments not all processes are carried out, or the processes could be combined or carried out at different manufacturing sites. For example, in one embodiment there may only be a tape slitting station which slits a web into a plurality of tapes. In such an embodiment the web may not be printed (i.e. it could be clear), and it may be pre-supplied with the release and adhesive coating. In other embodiments, the web may be printed at one site, adhesive and release coatings could be supplied at another site, and then the web may be slit into tapes in a tape slitting operation, without the need for primary slitting.

In the foregoing description a method and apparatus for manufacturing a reclose tape has been described. However, it should be appreciated that the method and apparatus may be suitable for manufacturing other types of tape. For example, it may be used to manufacture a permanent adhesive tape having one or more longitudinally extending dry-edges. Such a tape could be used for a variety of applications, for example it could be applied to packaging and used to tear through, or off, packaging to open it.

It should be appreciated that the dimensions given are only exemplary and other suitable dimensions could be chosen. The original web may have any suitable width and may be slit directly into a suitable number of tapes having any appropriate width, or into any number of narrower webs, again having any suitable width. Further, the width of the adhesive stripes and the spacing between them may be chosen depending on the application. The spacing and width chosen for the adhesive stripes, together with the transverse position at which slitting occurs will determine the size (or width) and number of dry fingerlift edges.

1. A method of manufacturing an adhesive tape, comprising:
printing a print pattern including at least one printed datum onto a web;
applying onto the web a plurality of transversely spaced adhesive stripes using an adhesive stripe applicator;
controlling adhesive stripe application such that the adhesive stripes are applied in register with the print pattern by monitoring the transverse position of at least a part of at least one printed datum and adjusting the relative transverse position between the adhesive stripe applicator and the web in response thereto;
a tape slitting operation in which, using a tape slitting head, the web is slit into a plurality of adhesive tapes which each have an adhesive stripe; and
controlling the tape slitting such that the web is slit in register with the print pattern by monitoring the transverse position of at least a part of at least one printed datum and adjusting the relative transverse position between the tape slitting head and the web in response thereto.

2. A method according to claim 1, wherein the print pattern comprises a plurality of transversely spaced printed datums.

3. A method according to claim 1 or 2, wherein the or each or some of the printed datums comprise printed lines or printed markers.

4. A method according to any preceding claim, wherein the or each printed datum extends in the web direction.

5. A method according to any preceding claim, wherein the print pattern is printed using one or more print cylinders.

6. A method according to any preceding claim, wherein the print pattern is printed using a gravure printing process.

7. A method according to any preceding claim, wherein the adhesive stripes are applied in register with one another.

8. A method according to any preceding claim, wherein the adhesive stripe applicator comprises a coating cylinder.

9. A method according to any preceding claim, wherein the adhesive stripes are applied using a gravure coating process.

10. A method according to any preceding claim, wherein controlling the adhesive stripe application comprises optically monitoring the transverse position of at least a part of at least one printed datum.

11. A method according to any preceding claim, wherein adjusting the relative transverse position between the adhesive stripe applicator and the web comprises transversely moving the web.

12. A method according to any preceding claim, wherein controlling the tape slitting comprises optically monitoring the transverse position of at least a part of at least one printed datum.

13. A method according to any preceding claim, wherein adjusting the relative transverse position between the tape slitting head and the web comprises transversely moving the tape slitting head.

14. A method according to any preceding claim, wherein the web is slit at positions in between adjacent adhesive stripes such that each adhesive tape comprises a central adhesive region disposed between non-adhesive edge regions.

15. A method according to any preceding claim, wherein the tape slitting head comprises a plurality of transversely spaced slitting elements.

16. A method according to claim 15, wherein the tape slitting elements comprise blades or knives.

17. A method according to claim 15 or 16, wherein the transverse spacing between the tape slitting elements is fixed.

18. A method according to any of claims 15-17, wherein the transverse spacing between the plurality of tape slitting elements substantially corresponds to the transverse spacing between the plurality of adhesive stripes.

19. A method according to any preceding claim, further comprising rewinding each adhesive tape onto a reel.

20. A method according to any preceding claim, further comprising applying a release coating onto the opposite side of the web to the side to which the adhesive stripes are applied.

21. A method according to any preceding claim, wherein the web subject to the tape slitting operation is a narrower web of the web to which the print pattern and/or adhesive stripes are applied to.

22. A method according to any preceding claim, further comprising a primary slitting operation, which is carried out prior to the tape slitting operation, in which, using a primary slitting head, the web is slit into a plurality of narrower webs which each have a plurality of transversely spaced adhesive stripes, wherein each narrower web is subsequently subject to the tape slitting operation.

23. A method according to claim 22, further comprising controlling the primary slitting by monitoring the transverse position of at least a part of at least one printed datum and adjusting the relative transverse position between the primary slitting head and the web in response thereto.

24. A method according to claim 22 or 23, wherein controlling the primary slitting comprises optically monitoring the transverse position of at least a part of at least one printed datum.

25. A method according to any of claims 22-24, wherein adjusting the relative transverse position between the primary slitting head and the web comprises transversely moving the primary slitting head with respect to the web.

26. A method according to any of claims 22-25, wherein the primary slitting head comprises a plurality of transversely spaced primary slitting elements.

27. A method according to claim 26, wherein the primary slitting elements comprise blades or knives.

28. A method according to claim 26 or 27, wherein the transverse spacing between the primary slitting elements is fixed.

29. A method according to any of claims 22-28, further comprising rewinding each narrower web onto a reel.

30. An apparatus for manufacturing an adhesive tape, the apparatus comprising:
a printing station for printing a print pattern including at least one printed datum onto a web;
a coating station comprising:
an adhesive stripe applicator for applying onto the web a plurality of transversely spaced adhesive stripes;
an adhesive stripe applicator controller arranged to control the application of adhesive stripes such that they are applied in register with the print pattern, comprising:
a datum monitor arranged to monitor the transverse position of at least a part of at least one printed datum; and
an adjuster arranged to adjust the relative transverse position between the adhesive stripe applicator and the web based on the monitored transverse position; and
one or more tape slitting stations, each comprising:
a tape slitter comprising a tape slitting head through which the web can be drawn so as to slit the web into a plurality of adhesive tapes which each have an adhesive stripe; and
a tape slitting controller arranged to control the tape slitting such that the web is slit in register with the printed pattern, the tape slitting controller comprising:
a datum monitor arranged to monitor the transverse position of at least a part of at least one printed datum; and
a tape slitting adjuster arranged to adjust the relative transverse position between the tape slitting head and the web based on the monitored transverse position.

31. An apparatus according to claim 30, wherein the or each or some of the printed datums comprise printed lines or printed markers.

32. An apparatus according to claim 30 or 31, wherein the or each printed datum extends in the web direction.

33. An apparatus according to any of claims 30-32, wherein the printing station comprises one or more print cylinders.

34. An apparatus according to any of claims 30-33, wherein the printing station comprises one or more gravure printing cylinders.

35. An apparatus according to any of claims 30-34, wherein the adhesive stripe applicator is arranged to apply the adhesive stripes in register with one another.

36. An apparatus according to any of claims 30-35, wherein the adhesive stripe applicator comprises one or more adhesive coating cylinders.

37. An apparatus according to any of claims 30-36, wherein the adhesive stripe applicator comprises one or more gravure coating cylinders.

38. An apparatus according to any of claims 30-37, wherein the datum monitor of the adhesive stripe applicator controller comprises an optical monitor arranged to optically monitoring the transverse position of at least a part of at least one printed datum.

39. An apparatus according to any of claims 30-38, wherein the adjuster of the adhesive stripe applicator controller is arranged to transversely move the web.

40. An apparatus according to any of claims 30-39, wherein the datum monitor of the tape slitting controller comprises an optical monitor arranged to optically monitor the transverse position of at least a part of at least one printed datum.

41. An apparatus according to any of claims 40-40, wherein the adjuster of the tape slitting controller is arranged to transversely move the tape slitting head.

42. An apparatus according to any of claims 30-41, wherein the tape slitter is arranged to slit the web at positions in between adjacent adhesive stripes such that each adhesive tape comprises a central adhesive region disposed in between non-adhesive edge regions.

43. An apparatus according to any of claims 30-42, wherein the tape slitting head comprises a plurality of transversely spaced slitting elements.

44. An apparatus according to claim 43, wherein the tape slitting elements comprise blades or knives.

45. An apparatus according to claim 43 or 44, wherein the transverse spacing between the tape slitting elements is fixed.

46. An apparatus according to any of claims 43-45, wherein the transverse spacing between the plurality of tape slitting elements substantially corresponds to the transverse spacing between the plurality of adhesive stripes.

47. An apparatus according to any of claims 30-46, wherein the tape slitting station further comprises a plurality of rewinders each for rewinding one of the plurality of adhesive tapes onto a reel.

48. An apparatus according to any of claims 30-47, wherein the coating station is arranged to apply a release coating onto the opposite side of the web to the side to which the coating station is arranged to apply adhesive stripes onto.

49. An apparatus according to any of claims 30-48, wherein the apparatus further comprises a primary slitting station comprising:
a primary slitter comprising a primary slitting head through which the web can be drawn so as to slit the web into a plurality of narrower webs which each have a plurality of transversely spaced adhesive stripes.

50. An apparatus according to claim 49, wherein the primary slitting station further comprises a primary slitting controller arranged to control the primary slitting, the primary slitting controller comprising:
a datum monitor arranged to monitor the transverse position of at least a part of at least one printed datum; and
a primary slitting adjuster arranged to adjust the relative transverse position between the primary slitting head and the web based on the monitored transverse position.

51. An apparatus according to claim 49 or 50, wherein the datum monitor comprises an optical monitor arranged to optically monitor the transverse position of at least a part of at least one printed datum.

52. An apparatus according to any of claims 49-51, wherein the primary slitting adjuster is arranged to transversely move the primary slitting head based on the monitored transverse position.

53. An apparatus according to any of claims 49-52, wherein the primary slitting head comprises a plurality of transversely spaced primary slitting elements.

54. An apparatus according to claim 53, wherein the primary slitting elements comprise blades or knives.

55. An apparatus according to claim 53 or 54, wherein the transverse spacing between the primary slitting elements is fixed.

56. An apparatus according to any of claims 49-55, wherein the primary slitting station further comprises a plurality of rewinders each for rewinding one of the plurality of narrower webs onto a reel.

57. An apparatus according to any of claims 30-56, wherein there are a plurality of tape slitting stations.

58. A method of manufacturing an adhesive tape or an apparatus for manufacturing an adhesive tape substantially as described herein with reference to the accompanying drawings.
